(19) United States
(12) Patent Application Publication
(10) Pub. No.: US 2004/0143565 A1
(43) Pub. Date: Jul. 22, 2004

(54) Deconvolution technique employing hermite functions

(76) Inventors: Henry Berger, Kingstown, VA (US); Edmundo Simental, Alexandria, VA (US)

Correspondence Address: HUMPHREYS ENGINEER CENTER SUPPORT ACTIVITY, ATTN: CEHEC-OC, 7701 TELEGRAPH ROAD, ALEXANDRIA, VA, 22315-3860, US

(21) Appl. No.: 10/658,285

(22) Filed: Sep. 10, 2003

(51) Int. Cl. G06F 7/00

(52) U.S. Cl. 707/1

(57) ABSTRACT

A procedure generates deconvolution algorithms by first solving a general convolution integral exactly. Results are transformed, yielding a linear relationship between actual (undistorted) and captured (distorted) data. Hermite functions and the Fourier-Hermite series represent the two data classes. It circumvents the need for solving incompatible systems of linear equations derived from “numerically discretizing” convolution integrals, i.e., the convolution integral is not evaluated. It is executed by exploiting a mathematical coincidence that the most common Point Spread Function (PSF) used to characterize a device is a Gaussian function that is also a Fourier-Hermite function of zero order. By expanding the undistorted data in a Fourier-Hermite series, the convolution integral becomes analytically integrable. It also avoids an inherent problem of dividing by decimal “noisy data” values in conventional “combined deconvolution” in that division is by a function of the PSF parameters yielding divisors generally greater than one.

### STATEMENT OF GOVERNMENT INTEREST

Under paragraph 1(a) of Executive Order 10096, the conditions under which this invention was made entitle the Government of the United States, as represented by the Secretary of the Army, to the entire right, title and interest therein of any patent granted thereon by the United States. This and related patents are available for licensing to qualified licensees. Please contact John Griffin at 703 428-6265 or Phillip Stewart at 601 634-4113.

### FIELD OF THE INVENTION

The present invention relates generally to mathematical processes for removing distortion from raw data that presents in a Gaussian distribution. In particular, it describes an efficient improved de-convolution procedure for data processing adapted according to specific needs of the user. It applies to all such measurements including optical and electro-optical measurements.

### BACKGROUND

Generally speaking, a measurement or imaging system introduces “distortion” into the “measurement” or image that is undesirable, i.e., it distorts the desired information. This occurs in all measuring systems. This undesirable distortion may be from a number of sources including the characteristics of the measuring system itself, the environment in which the measurable or image is embedded, the environment between the detector(s) of the measurement system and the item to be measured or imaged, the experience of the operator of the measuring system, etc. The resulting agglomeration of undesirable distortions that have been “added” to the actual data results from a “convolution” of one or more of these sources of undesirable information with the desired (actual or undistorted) data by the measuring or imaging system.

The process for getting actual (undistorted) data from measured (distorted) data involves implementing a “deconvolution” that attempts to reduce or eliminate the undesirable distortion. To do this, deconvolution techniques and deconvolution filters have been developed, some examples of which are represented in the following U.S. patents and published applications.

A number of U.S. patents involve some form of deconvolution technique or filter for which the methods of the present invention may provide an improvement. These include the following examples.

U.S. Pat. No. 5,185,805, Tuned Deconvolution Digital Filter for Elimination of Loudspeaker Output Blurring, to Chiang, Feb. 9, 1993, is incorporated herein by reference. The response of a speaker to a known analog signal is sampled at or above the Nyquist rate and the result is used to construct a linear, time invariant deconvolution filter that compacts the blurred output signal back into its original (unblurred) form. The frequency response is then improved by a fine-tuning process using Lagrange's Method of Multipliers.

U.S. Pat. No. 5,400,265, Procedure for Enhancing Resolution of Spectral Information, to Kauppinen, Mar. 21, 1995, is incorporated herein by reference. The Fourier Self-Deconvolution (FSD) method is used to enhance resolution of spectral data. The Maximum Entropy Method (MEM) is then used to predict filter error coefficients. Using data from the FSD and the MEM and the Linear Prediction (LP) method, data are predicted beyond the area provided by the FSD to maximize spectral line narrowing with minimal distortion.

U.S. Pat. No. 5,400,299, Seismic Vibrator Signature Deconvolution, to Trantham, Mar. 21, 1995, is incorporated herein by reference. A deterministic signature deconvolution of the data compresses the impulse response of the data resulting in sharper seismic images than possible using cross correlation techniques.

U.S. Pat. No. 5,748,491, Deconvolution Method for the Analysis of Data Resulting from Analytical Separation Processes, to Allison et al., May 5, 1998, is incorporated herein by reference. A signal representing multiple partially separated sample zones is measured, a Point Spread Function (PSF) determined, and a Fourier transform of the data performed. A noise component of the signal is determined and a value for a resulting signal is determined using a specific filter. The inverse Fourier Transform is then taken to get the desired result. Although a Gaussian PSF is preferred for use in the process, a method is provided for surveying a number of PSF possibilities serially.

U.S. Pat. No. 5,761,345, Method of Discrete Orthogonal Basis Restoration, to Moody, Jun. 2, 1998, is incorporated herein by reference. The method applies to linear data and involves estimating a signal-to-noise ratio (SNR) for a restored signal or image. A set of orthogonal basis functions is then selected to provide a stable inverse solution based on the estimated SNR. Time or spatially varying distortions in the restored system are removed and an appropriate inverse solution vector obtained.

U.S. Pat. No. 5,862,269, Apparatus and Method for Rapidly Convergent Parallel Processed Deconvolution, to Cohen et al., Jan. 19, 1999, is incorporated herein by reference. Provided is a stand-alone image processing system and method for deconvolution or an initiator for rapid convergence of conventional deconvolution methods. The method improves processing speed by relaxing the sequential requirement of the CLEAN method. The number of iterations is reduced by fractional removal of noise for multiple image features during the processing of a single subtractive iteration.

U.S. patent application publication no. 2002/0156821 Al, Signal Processing Using the Self-Deconvolving Data Reconstruction Algorithm, by Caron, Oct. 24, 2002, is incorporated herein by reference. A filter function is extracted from degraded data by mathematical operations applying a power law and smoothing function in frequency space. The filter function is used to restore the degraded content through any deconvolution algorithm without prior knowledge of the detection system, i.e., blind deconvolution.

U.S. patent application publication no. 2002/0136133 Al, Superresolution in Periodic Data Storage Media, by Kraemer et al., Sep. 26, 2002, is incorporated herein by reference. A method termed Matrix-Method Deconvolution (MMD) compensates for the effects of an optical addressing system's PSF. Prior knowledge of the PSF and inter-memory center spacing is used to acquire binary data stored physically in a periodic storage medium.

Optical and electro-optical devices cause intrinsic distortion of the image or spectral characteristic they sense, measure or record. This distortion is separate from any measurement noise or artifact noise that may be present. The mathematical relationship between the undistorted and “intrinsically distorted” images or spectra is described by an equation incorporating a convolution integral. Blass, W. E. and G. W. Halsey, Deconvolution of Absorption Spectra, Academic Press, New York, 1981. Jansson, P. A., Ed., Deconvolution of Images and Spectra, Academic Press, New York, 1997.

The measured (distorted) image equals the convolution integral of the product of the actual (undistorted) image and the point spread function (PSF) that stochastically characterizes the device. (Consider a very small point of light. If the visual system had perfect optics the image of this point on a lens would be identical to the original point of light. Referring to FIG. 1, if the relative intensity of this point of light were plotted as a function of distance on the lens, such a plot would look like the dashed vertical line. However, the optics are not perfect so the relative intensity of the point of light may be distributed across the lens as shown by the curved line. This curve is the PSF.)

Conventionally deriving an undistorted image or spectra from an intrinsically distorted one may be attempted initially by a stand-alone process termed classical deconvolution. Unlike the convolution integral, deconvolution is not a well-defined mathematical operation, i.e., only the desired goal is well defined.

Because of the disadvantages of the deconvolution process, some have offered solutions to completely avoid it. See, for example, U.S. Pat. No. 3,934,485, Method and Apparatus for Pulse Echo Imaging, to Beretsky et al., Jan. 27, 1976.

Some authors use the term “deconvolution” for what is actually a combination of classical (intrinsic) deconvolution and one of several special iteration techniques. Blass (1981). Jansson (1997). Mou-yan, Z. et al., On the Computational Model of a Kind of Deconvolution Problem, IEEE Trans. Image Process, 4, No. 10, pp. 1464-1476, October 1995. This is a long-standing problem in deconvolution research, i.e., extracting an undistorted image from solutions to incompatible systems of linear equations derived from “discretizing” (not merely digitizing) convolution integrals. This discretizing yields a system of linear equations that relate the actual (undistorted) and captured (distorted) images in deconvolution. Twomey, S., Introduction to the Mathematics of Inversion in Remote Sensing and Indirect Measurements, Elsevier Sci. Pub., pp. 33-35, 1977.

Many classical deconvolution techniques, when used alone, produce large unacceptable errors. To reduce these errors, the aforementioned linear iteration techniques are used with intrinsic deconvolution. Used together, the combination, after many iterations, may produce acceptable error levels. Use of these combinations also may increase signal-to-noise ratios (SNRs). Blass (1981). Jansson (1997). Mou-yan et al. (1995).

A recent patent details use of the Hermite Functions to improve performance of a sonar system. U.S. Pat. No. 6,466,515 B1, Power-Efficient Sonar System Employing a Waveform and Processing Method for Improved Range Resolution at High Doppler Sensitivity, to Alsup et al., Oct. 15, 2002, is incorporated herein by reference. A sonar system incorporates a comb-like waveform by modulating its lines according to a set of Hermite functions defining a Hermite Function Space (HFS). Doppler sensitivity akin to CW systems is realized by applying to the HFS signals, the deconvolution method of the '515 patent. Although Hermite Functions are used, they are not used to simplify the deconvolution of received data.

Thus, although a number of “combined” deconvolution techniques are known, difficulties arise in applying many of them. The present invention provides a solution that overcomes such difficulties.

### SUMMARY

A unique deconvolution procedure adapts to generate unique deconvolution algorithms for each different requirement. This is accomplished by first solving the general convolution equation exactly, in closed analytical form. Mou-Yan, Z. et al., New Algorithms of Two-Dimensional Blind Deconvolution, Opt. Eng., No. 10, pp. 2945-2956, October 1995. Next, the results are transformed, leading to a fundamentally new linear relationship between the actual (undistorted) and the captured (distorted) images.

To do this, a preferred embodiment of the present invention uses the Hermite functions and the Fourier-Hermite series to represent the two classes (distorted and undistorted) of images. Using this procedure leads to the exact solution of the convolution integral.

A preferred embodiment of the present invention provides a way around the need for solving incompatible systems of linear equations derived from “discretizing” convolution integrals. No numerical evaluation of the convolution integral is required in the present invention.

A preferred embodiment of the present invention is executed by exploiting a remarkable mathematical coincidence. The mathematical coincidence is that the most common PSF used to characterize a device is a Gaussian function (see FIG. 1). The Gaussian function is also a Fourier-Hermite function of zero order.

Exploitation of this fact permits exact analytic evaluation of the convolution integral for most optical imaging systems and some non-optical systems. The mathematics is processed in exact closed form, followed by analytic deconvolution. Further, the present invention addresses an additional concern. When employing conventional “combined deconvolution,” image distortion may also result because of the numerical division of very noisy data represented by PSF “points” having values less than one. Division in the present invention is by a new function of the PSF parameters yielding values generally greater than one.

If desired, the procedure may be used with any of the iterative techniques to further refine the image. Finally, if used with an iterative technique, fewer iterations will be needed because of the inherently more accurate starting point provided by the procedure.

Specifically provided is a process for deconvolving data collected by a device the point spread function response of which follows a Gaussian distribution. The process accurately estimates actual parameters derivable from this “captured” data. It comprises:

forming a mathematical relationship having a first mathematical equivalent of the captured data on one side of an equality and a second mathematical equivalent of actual parameters on the other side of the equality;

selecting an order, m, of a Hermite function for modifying this mathematical relationship;

modifying the mathematical relationship to form Hermite functions therein to permit identification of like items, each having a coefficient, on each side of the equality, the coefficients associated with the actual parameters being unknowns;

developing a set of linear equations from this mathematical relationship that relate to the coefficients of the like items; and

solving this set of linear equations for the unknown coefficients to produce an exact solution to the convolution; and

deconvolving this set of linear equations to determine the unknown coefficients.

The process may also initiate any conventional iterative deconvolution techniques to further refine the data, such that fewer iterations will be needed because of provision of an accurate starting point.

Specifically, a preferred embodiment of the present invention is a process for deconvolving output from detectors whose point spread function follows a Gaussian distribution. The process accurately estimates environments derivable from the detectors' output. The process comprises:

forming a mathematical relationship having the mathematical equivalent of the output on one side of an equality and the mathematical equivalent of the environments on the other side;

selecting an order, m, of a Hermite function for modifying this equality, such that m also determines the number of terms for the representation of the environments;

modifying the mathematical relationship to form Hermite functions therein, such that forming the Hermite functions permits identification of like items, each having a coefficient, on each side of the equality;

developing a set of linear equations from the equality that relate to the coefficient of each of the like items; and

solving the set of linear equations for the unknown coefficients of the like items to produce an exact solution to the convolution, in turn, permitting deconvolution using simple linear relationships.

Also, this embodiment may be used to initiate any conventional iterative nonlinear deconvolution techniques to further refine the output such that fewer iterations are needed because of the provided accurate starting point.

In yet another preferred embodiment of the present invention is provided a process yielding accurate representations of actual image data by deconvolving image data collected by optical detectors whose point spread function response follows a Gaussian distribution. The process comprises:

establishing a mathematical relationship as a general optical convolution integral equating the actual image data to the collected image data;

selecting a Fourier-Hermite function;

employing a generating function for Hermite polynomials for expanding a Fourier-Hermite series of the Fourier-Hermite function to establish a linear mathematical relationship between the actual and the collected image data;

selecting an order, m, of the Fourier-Hermite polynomial such that m also determines the number of terms for the representation of the images;

expanding the actual image data in a Fourier-Hermite form with unknown (to-be-determined) coefficients by employing a series of special transformations to convert the side of the mathematical relationship representing the actual image to a Fourier-Hermite series;

expanding the collected image data in a Fourier-Hermite form;

equating coefficients of like terms on each side of the mathematical relationship to relate the coefficients of the actual and collected images;

selecting a linear convolution algorithm from which a general convolutional equation is derived;

solving the resultant general convolution equation exactly, in closed analytical form, as a linear convolution equation, such that using this process to evaluate the general convolution integral yields a form proportional to a Gaussian function times a power series that is defined with a finite number of terms, m, and incorporates the unknown coefficients of the actual image data as presented in a Hermite function, such that a solution in closed analytic form provides a satisfactory solution to the general convolution integral without approximation; and

performing an analytic deconvolution of the resultant linear convolution algorithm by employing classical deconvolution algorithms solely, such that the analytic deconvolution yields a solution having acceptable error levels.

As with other embodiments, this process may be used to initiate any conventional iterative nonlinear deconvolution techniques to further refine the accurate representations and fewer iterations are needed because of the accurate starting point provided.

A preferred embodiment of the present invention for deconvolving captured (distorted) optical, or other, measurements has the following advantages:

it completely circumvents the long-standing problem of having to use solutions from incompatible systems of linear equations derived from discretizing convolution integrals;

it eliminates concern about discernible image distortion introduced by the imaging process itself in addition to that from the measuring device, e.g., a detector array;

it automatically provides the unique algorithm(s) needed for the specific requirements of the user;

it solves both the convolution and the deconvolution algorithms exactly through a system of related linear equations, not as an estimate based on an iterative process;

it may be used with existing iterative processes, reducing the number of iterations required while further refining an image, if required; and

it capitalizes on the unique characteristics of Hermite functions, enabling calculations in the frequency (wave number) domain as easily as in the time domain.

Applications in the imaging field include:

straightforward calculation of the actual (undistorted) measurement from the collection system's (distorted) measurement;

removal of distortions from image data; and

assessment of the accuracy of a given convolution.

Further advantages of the present invention will be apparent from the description below with reference to the accompanying drawings, in which like numbers indicate like elements.

### BRIEF DESCRIPTION OF THE DRAWINGS

FIG. 1 is a representation of a point spread function (PSF) compared to a theoretically perfect representation of a single point of light as may be captured by a lens.

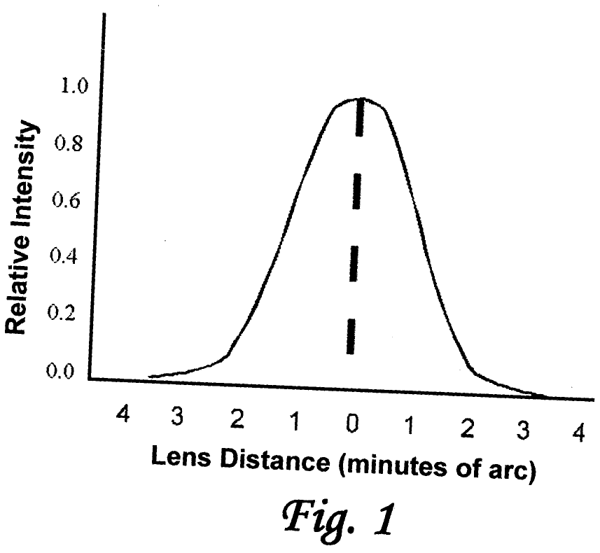

FIG. 2 is a flow chart representing general steps used in implementing a preferred embodiment of the present invention.

### DETAILED DESCRIPTION

There is concern about some of the numerical division operations that are a part of deconvolution algorithms. Concerns center on the division of a value associated with a signal datum that is mostly noise by the actual value of the PSF when the PSF is a very small percentage of its peak value, such as in the tails of a PSF represented by a Gaussian distribution. Of course, the peak value of the PSF, by definition, is one. It can be seen that such operations, i.e., division by a number much smaller than one, will magnify the contribution of the noisy datum. This produces significant distortion as a result of processing alone. This is then combined with the physical distortion introduced by the collection device itself.

The Hermite-function method, proposed as a preferred embodiment of the present invention, prevents, or at least significantly reduces the chances of, these small values being used as a divisor. This algorithm provides for dividing by a function of the parameters of the PSF, as opposed to the actual values of the PSF. Thus, proposed is a function of the PSF, ƒ(PSF), independent of the point at which the PSF is being used. For most devices, this function is rarely much less than one, leading to little chance of magnifying a noisy datum.

The actual (undistorted) measurement is expanded in a Fourier-Hermite form with to-be-determined coefficients. This leads to the need to evaluate convolution integrals of the form:

$${Y}_{m} = {\int }_{- ∞}^{∞} {ⅇ}^{- \frac{{( z - x )}^{2}}{2}} {ⅇ}^{- \frac{{x}^{2}}{2}} {H}_{m} ( x ) ⅆ x \qquad ( 1 )$$

where:

PSF is represented by:

$${Pe}^{\frac{{x}^{2}}{2}} , 0 < P < 1 ,$$

displaced PSF is represented by

$${ⅇ}^{\frac{{( z - x )}^{2}}{2}} ,$$

the Hermite Function is represented by

$${ⅇ}^{\frac{- {x}^{2}}{2}} {H}_{m} ( x ) ,$$

and

Hₘ(x) is the Hermite polynomial of order m.

By way of introduction to the development of the theory behind the present invention, the “convolutional” relationship between the true and distorted measurements (or images) is given by:

The recorded (distorted) image may be expressed as a convolution integral of the form:

∫[PSF(x−y)][TRUEIMAGE(y)]dy (2)

Suppose the convolutional equation relating the distorted and undistorted images could be solved exactly. Further, suppose the two sides of the equation can be manipulated to be of the same form. Thus, equating coefficients of like terms directly relates the parameters of the two images (distorted and actual), ultimately determining the desired algorithm.

An expression for an actual (undistorted) image, I(x), in terms of a Hermite function is:

$$I ( x ) = {ⅇ}^{- \frac{{y}^{2}}{2}} {\sum }_{m = 0}^{∞} {I}_{m} {H}_{m} ( y ) \qquad ( 3 )$$

where Hₘ(y) is the Hermite polynomial of order, m; and

$$y = {α}^{\frac{1}{2}} x \qquad ( 4 )$$

where:

x the spatial variable and

α=an arbitrary parameter

Pauling, L. and E. Bright Wilson, Introduction to Quantum Mechanics, p. 80, McGraw-Hill, 1935. The Pauling reference includes a normalization factor that is a function of α. Since the factor is a constant, it has been absorbed in Iₘ.

The general convolutional relationship between the actual (undistorted) and captured (distorted) measurements (images) is given by:

D(z)=∫p(z−x)I(x)dx (5)

where:

D(z)=captured measurement;

I(x)=actual value of the measurement;

p(x)=point spread function (PSF) characterizing the measuring device, such as an optical or electro-optical imaging system

In most cases, p(x) may be described by:

$$p ( x ) = P {ⅇ}^{- \frac{{( x - d )}^{2}}{2 a}} \qquad ( 6 )$$

where:

P is (2πb)^{1/2}, the multiplicative “amplitude” of the Gaussian;

a is a constant related to a measure of the “width” of the Gaussian;

b is a constant that is an inverse measure of the “amplitude” of the Gaussian; and

d is the displacement of Gaussian peak from the origin, normally zero

Thus, the resulting form of P is in terms of a and b (d normally zero). When a=b, the integral of p(x) over all x is unity. P can never be greater than unity and for simplicity it is chosen as unity.

When the PSF can be modeled by a Gaussian curve written as

$$p ( x ) = P {ⅇ}^{\frac{- {x}^{2}}{2 a}} \qquad ( 7 )$$

where:

a=a constant,

b=a constant

Expanding the unknown undistorted measurement (actual image), I(x), and the measured (distorted image), D(R), in Fourier-Hermite representations:

$$\begin{matrix}I ( x ) = {ⅇ}^{- \frac{α {x}^{2}}{2}} {\sum }_{m = 0}^{∞} {I}_{m} {H}_{m} ( x {α}^{\frac{1}{2}} ) & ( 8 ) \\ and & \\ D ( R ) = {\sum }_{m = 0}^{∞} {D}_{m} {ⅇ}^{- \frac{{R}^{2}}{2}} {H}_{m} ( R ) & ( 9 )\end{matrix}$$

Iₘ represents unknown coefficients that when solved for represent the solution of the deconvolution problem. Dₘ represents known coefficients needed to represent D(R). Also, α is and arbitrary parameter that is later constrained by the requirement of physical “realizability” of the description.

D(R) and I(x) are related through the definitive equation containing the convolutional integral

$$D ( z ) = {\int }_{- ∞}^{∞} p ( z - x ) I ( x ) ⅆ x \qquad ( 10 )$$

Integrating the right hand side (RHS) of Eqn. (10), a polynomial, Iₘ(R)^{m}, results. This polynomial must be transformed into the Hermite Polynomial form, JₘHₘ(R), where Jₘ is related to Iₘ by a linear transformation the details of which depend on the order of the polynomial, m.

The results produce identical structure on both sides of the equation, enabling the coefficients of like terms to be equated. A set of linear equations relating parameters of the distorted and undistorted images may now be written. Writing:

$$C = {( \frac{a}{2 b} )}^{\frac{1}{2}} \qquad ( 11 )$$

yields a system of linear equations:

Dₘ=CJₘ (12)

$$C = {( \frac{a}{2 b} )}^{\frac{1}{2}}$$

that may be used to solve the convolution problem.

Further, Eqn. (11) and (12) may be used to solve for Jₘ and hence, Iₘ, yielding the solution to the deconvolution problem. The common divisor, C, or a common multiplier, E, may be used, where E=1/C. Thus,

$$E = {( \frac{2 b}{a} )}^{\frac{1}{2}} \qquad ( 13 )$$

so that

Jₘ=EDₘ (14)

Thus, the solution to the deconvolution problem can be expressed as

$${D}_{n} = {\sum }_{m = 0}^{n} {C}_{n} {J}_{m} = C {\sum }_{m = 0}^{n} {J}_{m} \qquad ( 15 )$$

A process leading to a relationship equivalent to the integral of Eqn. (1) but able to be easily evaluated establishes a preferred embodiment of the present invention. The artifice of using a generating function for Hermite polynomials enables this.

One generating function for Hermite polynomials is:

$$T ( x , t ) = {ⅇ}^{- {t}^{2} + 2 tx} = \sum [ \frac{{H}_{m} ( x )}{m !} ] {t}^{m} \qquad ( 16 )$$

where t is a dummy variable.

A usable integral may be created using the generating function as follows:

$$Π = \int T ( x , t ) {ⅇ}^{- \frac{{( z - x )}^{2}}{2}} {ⅇ}^{- \frac{{x}^{2}}{2}} ⅆ x \qquad ( 17 )$$

Substituting the exponential definition in Eqn. (1) into Eqn. (17):

$$Π = \int {ⅇ}^{- {t}^{2} + 2 tx} {ⅇ}^{- \frac{{( z - x )}^{2}}{2}} {ⅇ}^{- \frac{{x}^{2}}{2}} ⅆ x \qquad ( 18 )$$

or the alternative summation definition in Eqn. (16) into Eqn. (17):

$$Π = \int {ⅇ}^{- \frac{{( z - x )}^{2}}{2}} {ⅇ}^{- \frac{{x}^{2}}{2}} \sum [ \frac{{H}_{m} ( x )}{m !} ] {t}^{m} ⅆ x \qquad ( 19 )$$

or:

$$Π = \frac{{t}^{m}}{m !} \sum \int {ⅇ}^{- \frac{{( z - x )}^{2}}{2}} {ⅇ}^{- \frac{{x}^{2}}{2}} {H}_{m} ( x ) ⅆ x \qquad ( 20 )$$

Note that the integral in Eqn. (20) is Yₘ of Eqn. (1).

Setting the right hand side of Eqn. (18) equal to the right hand side of Eqn. (20) produces:

$$\int {e}^{- {t}^{2} + 2 tx} {ⅇ}^{- \frac{{( z - x )}^{2}}{2}} {ⅇ}^{- \frac{{x}^{2}}{2}} ⅆ x = \frac{{t}^{m}}{m !} \sum \int {ⅇ}^{- \frac{{( z - x )}^{2}}{2}} {ⅇ}^{- \frac{{x}^{2}}{2}} {H}_{m} ( x ) ⅆ x \qquad ( 21 )$$

Noting that exponents add, collecting all exponents within the integral on the right hand side of Eqn. (17), and setting this to equal E:

$$\begin{matrix}E = - [ ( {t}^{2} - 2 tx ) + \frac{{( z - x )}^{2}}{2} + \frac{{x}^{2}}{2} ] & ( 22 ) \\ or \text{:} & \\ E = - [ {t}^{2} - 2 tx + \frac{( {z}^{2} - 2 zx + {x}^{2} )}{2} + \frac{{x}^{2}}{2} ] & ( 23 ) \\ or \text{:} & \\ E = - ( {t}^{2} - 2 tx + \frac{{z}^{2}}{2} - zx + \frac{{x}^{2}}{2} + \frac{{x}^{2}}{2} ) & ( 24 ) \\ or \text{:} & \\ E = - [ {t}^{2} - x ( 2 t + z ) + \frac{{z}^{2}}{2} + {x}^{2} ] & ( 25 )\end{matrix}$$

Define:

z=2y (26)

and rewrite Eqn. (25) using Eqn. (26):

E=−[t²−2x(t+y)+2y²+x²] (27)

Also define:

F=−[x−(y+t)]² (28)

or:

F=−[x²−2x(y+t)+(y+t)²] (29)

or:

F=−[x²−2x(y+t)+y²+2yt+t²] (30)

Thus,

E−F=−[y²−2yt] (31)

Substituting Eqn. (27) into the left hand side of Eqn. (17) and defining this as R:

R=∫e^{-(F+y}^{²}^{-2yt)}dx (32)

or:

R=e^{-(y}^{²}^{-2yt)}∫e^{-F}dx (33)

so that:

R=e^{-(y}^{²}^{-2yt)}∫e^{-[x-(y+t)]}^{²}dx (34)

and, since y and t are constants, thus dx=dy=0, then R may be expressed as:

R=e^{-(y}^{²}^{-2yt)}∫e^{-[x-(y+t)]}^{²}d[x−(y+t)] (35)

Setting:

w=x−(y+t) (36)

then:

R=e^{-(y}^{²}^{-2yt)}∫e^{-w}^{²}dw (37)

but:

$${\int }_{- ∞}^{∞} {ⅇ}^{- {w}^{2}} ⅆ w = {π}^{\frac{1}{2}} \qquad ( 38 )$$

Thus, Eqn. (37) becomes:

$$R = {π}^{\frac{1}{2}} {ⅇ}^{- ( {y}^{2} - 2 yt )} \qquad ( 39 )$$

Substituting Eqn. (39) into Eqn. (20):

$$\sum \frac{{t}^{m}}{m !} {Y}_{m} = R = {π}^{\frac{1}{2}} {ⅇ}^{- ( {y}^{2} - 2 yt )} \qquad ( 40 )$$

A Taylor Expansion of e^{2yt} provides:

$$\begin{matrix}{ⅇ}^{2 yt} = 1 + \frac{2 yt}{1 !} + \frac{{( 2 yt )}^{2}}{2 !} + … + \frac{{( 2 yt )}^{m}}{m !} + … & ( 41 ) \\ or \text{:} & \\ {ⅇ}^{2 yt} = \sum \frac{{( 2 yt )}^{m}}{m !} & ( 42 )\end{matrix}$$

Substituting Eqn. (42) into Eqn. (40) yields:

$$\sum \frac{{t}^{m}}{m !} {Y}_{m} = {π}^{\frac{1}{2}} {ⅇ}^{- {y}^{2}} \sum \frac{{( 2 yt )}^{m}}{m !} \qquad ( 43 )$$

Equating coefficients of like terms:

$$\frac{{t}^{m}}{m !} {Y}_{m} = {π}^{\frac{1}{2}} {ⅇ}^{- {y}^{2}} \frac{{( 2 yt )}^{m}}{m !} \qquad ( 44 )$$

such that:

$${Y}_{m} = {π}^{\frac{1}{2}} {{ⅇ}^{- {y}^{2}} ( 2 y )}^{m} \qquad ( 45 )$$

Substituting Eqn. (26) in Eqn. (45):

$${Y}_{m} = {π}^{\frac{1}{2}} {{ⅇ}^{- \frac{{z}^{2}}{4}} ( z )}^{m} \qquad ( 46 )$$

Upon integration of Eqn. (5), a polynomial form, Iₘ(R)^{m}, results and must be transformed back into the Hermite polynomial form, JₘHₘ(R), where Jₘ is related to Iₘ by a linear transformation which depends on the order, m, of the polynomial.

Eqn. (5) can be solved exactly. Further, the two sides of Eqn. (5) may be represented in the same form. Equating coefficients of like terms enables direct relationship of the parameters of the two measurements (actual and captured), which then determines the required algorithms.

The present invention makes use of the observation that most optical and electro-optical devices, as well as many other measurement systems, are characterized by a Gaussian PSF. Only the constants in the Gaussian vary from system to system. Note that the PSF appears within the convolution integral. Three aspects of the solution merge here.

First, Gaussian functions are part of a larger class of functions and are Hermite functions of zero order. Second, the actual (undistorted) measurement or image usually may be represented by a Fourier-Hermite series. Note also that the actual (undistorted) measurement or image is also defined within the convolution integral. Finally, the combination of the first two aspects allows the closed-form, analytic evaluation of the nearly general convolution integral without approximation, with the exception that the series are finite in length. In the above case, it is an optical convolution integral, but the process would work for any device the response of which may be described with a Gaussian distribution. Thus, using this approach, the common method of “discretizing” is avoided and there is no large system of linear equations that may be incompatible and may lead to meaningless results.

A preferred embodiment of the present invention, i.e., an evaluation of the convolution integral, yields a form proportional to a Gaussian function times a power series involving the unknown parameters of the actual (undistorted) measurement or image. Using a series of special transformations, the side of the equation representing the actual (undistorted) image may be changed into a separate Fourier-Hermite series.

Since the side of the equation representing the captured (distorted) measurement or image may be represented by a Fourier-Hermite series also, the two sides will have identical structure. Equating coefficients of like terms now directly relates the parameters of the two measurements or images (actual and captured), and permits selection of the required algorithms. The only non-numeric constants in the results are the parameters of the PSF that have been measured for the individual device or device type. Developing this concept further by substituting Eqn. (6) for p(x) into Eqn. (5) yields:

$$D ( z ) = \int {ⅇ}^{- \frac{{( z - x )}^{2}}{2 a}} I ( y ) ⅆ x \qquad ( 47 )$$

Substituting Eqns. (3) and (4) into Eqn. (47) yields:

$$\begin{matrix}D ( z ) = \int {ⅇ}^{- \frac{{( z - x )}^{2}}{2 a}} {ⅇ}^{- \frac{{y}^{2}}{2}} \sum {I}_{m} {H}_{m} ( y ) ⅆ x & ( 48 ) \\ or & \\ D ( z ) = P \sum {I}_{m} \int {ⅇ}^{- \frac{{( z - x )}^{2}}{2 a}} {H}_{m} ( y ) {ⅇ}^{- \frac{{y}^{2}}{2}} ⅆ x & ( 49 )\end{matrix}$$

If the integral on the right side of Eqn. (49) are designated Yₘ, then:

$${Y}_{m} = \int {ⅇ}^{- \frac{{( z - x )}^{2}}{2 a}} {ⅇ}^{- \frac{{y}^{2}}{2}} {H}_{m} ( y ) ⅆ x \qquad ( 50 )$$

Since Yₘ represents a value for the m^{th} mode, the sum substituted in Eqn. (49) is:

D(z)=PΣIₘYₘ (51)

To evaluate the integral, choose:

$$\begin{matrix}{ⅇ}^{- \frac{{( x )}^{2}}{2 a}} = {ⅇ}^{- \frac{{y}^{2}}{2}} = {ⅇ}^{- \frac{{x}^{2} α}{2}} & ( 52 ) \\ Thus , & \\ \frac{{x}^{2}}{2 a} = \frac{{x}^{2} α}{2} & ( 53 ) \\ or & \\ α = \frac{1}{a} & ( 54 )\end{matrix}$$

Substituting Eqns. (4) and (54) into Eqn. (3):

$$I ( x ) = {ⅇ}^{- \frac{{x}^{2}}{2 a}} \sum {I}_{m} {H}_{m} ( x ) {a}^{- \frac{1}{2}} \qquad ( 55 )$$

and the integral in Eqn. (50) becomes:

$${Y}_{m} = \int {ⅇ}^{- \frac{{( z - x )}^{2}}{2 a}} {ⅇ}^{- \frac{{x}^{2}}{2 a}} {H}_{m} ( x ) {a}^{- \frac{1}{2}} ⅆ x \qquad ( 56 )$$

Let:

$$v = {a}^{- \frac{1}{2}} x \qquad ( 57 )$$

so that

$$d x = {a}^{\frac{1}{2}} d v \qquad ( 58 )$$

and let

$$t = {a}^{- \frac{1}{2}} z \qquad ( 59 )$$

then Eqn. (56) may be re-written as:

$${Y}_{m} = {a}^{\frac{1}{2}} \int {ⅇ}^{- \frac{{( t - v )}^{2}}{2}} {ⅇ}^{- \frac{{v}^{2}}{2}} {H}_{m} ( v ) ⅆ v \qquad ( 60 )$$

Eqn. (60) is now of the form of the convolution integral where a=1. The result obtained for the convolution integral is:

$${Y}_{m} = {π}^{\frac{1}{2}} {ⅇ}^{- \frac{{t}^{2}}{4}} {t}^{m} \qquad ( 61 )$$

and for a≠1 is:

$${Y}_{m} = {( a π )}^{\frac{1}{2}} {ⅇ}^{- \frac{{t}^{2}}{4}} {t}^{m} \qquad ( 62 )$$

Substituting the definition of t from Eqn. (59) into Eqn. (62) yields:

$${Y}_{m} = {( a π )}^{\frac{1}{2}} {{ⅇ}^{- \frac{{z}^{2}}{4 a}} ( z {a}^{\frac{1}{2}} )}^{m} \qquad ( 63 )$$

To represent as a Fourier-Hermite series, let:

$$\begin{matrix}\frac{{R}^{2}}{2} = \frac{{z}^{2}}{4 a} & ( 64 ) \\ or & \\ R = \frac{z}{{( 2 a )}^{\frac{1}{2}}} & ( 65 )\end{matrix}$$

so that Eqn. (63) may be written:

$${Y}_{m} = {( π a )}^{\frac{1}{2}} {2}^{\frac{m}{2}} {ⅇ}^{- \frac{{R}^{2}}{2}} {R}^{m} \qquad ( 66 )$$

Multiplying (πa)^{1/2} by P⁻¹ or (2πb)^{-1/2} yields:

$${Y}_{m} = {( \frac{a}{2 b} )}^{\frac{1}{2}} {2}^{\frac{m}{2}} {ⅇ}^{- \frac{{R}^{2}}{2}} {R}^{m} \qquad ( 67 )$$

Inserting Eqn. (67) in Eqn. (51) produces:

$$D ( z ) = {( \frac{a}{2 b} )}^{\frac{1}{2}} \sum {{I}_{m} ( 2 )}^{\frac{m}{2}} {{ⅇ}^{- \frac{{R}^{2}}{2}} ( R )}^{m} \qquad ( 68 )$$

This expression now approaches the form of a Fourier-Hermite series because R^{m} can be expressed as a linear sum of weighted Hermite polynomials. Rewriting Eqn. (68):

$$D ( z ) = {( \frac{a}{2 b} )}^{\frac{1}{2}} \sum {2}^{\frac{m}{2}} {ⅇ}^{- \frac{{R}^{2}}{2}} {J}_{m} {H}_{m} ( R ) \qquad ( 69 )$$

Note that the Fourier-Hermite series can represent an almost arbitrary function in the same sense that the common sin(x), cos(x) series of the Fourier Series does.

The Fourier-Hermite representation of D(R) has the general form:

$$D ( R ) = {\sum }_{m = o}^{∞} {D}_{m} {ⅇ}^{- \frac{{R}^{2}}{2}} {H}_{m} ( R ) \qquad ( 70 )$$

where values of Dₘ are constants and the m^{th} value of Hₘ(R) is represented by the m^{th} order Hermite polynomial. Dₘ values are determined from Hₘ(R) by:

$${D}_{m} = {( m ! 2 m π )}^{- 1} {\int }_{- ∞}^{∞} D ( R ) {ⅇ}^{- \frac{{R}^{2}}{2}} {H}_{m} ( R ) ⅆ R \qquad ( 71 )$$

In practice, a finite number of terms in the series of Eqn. (70) is used to represent D(R). Assuming that finite number to be M, Eqn. (70) may be re-written as:

$$D ( R ) = {\sum }_{m = o}^{M} {D}_{m} {ⅇ}^{- \frac{{R}^{2}}{2}} {H}_{m} ( R ) \qquad ( 72 )$$

The number of terms, M, selected here will also determine the number of terms for the representation of the actual (undistorted) measurement or image, I(x). The value chosen for M determines the specific structure of the algorithm that the procedure produces. This provides some flexibility for the user in meeting the possibly competing requirements of computational efficiency and image “sharpness,” for example.

Based on the “basic” convolution equation of Eqn. (5), substitute the RHS of Eqn. (69) for the LHS of Eqn. (5) and the RHS of Eqn. (72) for the RHS of Eqn. (5), yielding:

$${ⅇ}^{- \frac{{R}^{2}}{2}} {\sum }_{m = o}^{M} {D}_{m} {H}_{m} ( R ) = {( \frac{a}{2 b} )}^{\frac{1}{2}} {ⅇ}^{- \frac{{R}^{2}}{2}} {\sum }_{m = 0}^{M} {2}^{\frac{m}{2}} {J}_{m} {H}_{m} ( R ) \qquad ( 73 )$$

Because both sides of Eqn. (73) now have identical structures, coefficients of like terms may be equated. A set of linear equations relating parameters of the captured (distorted) and actual (undistorted) images may be produced. Using the set of Eqns. (11) and (12) provides a system of linear equations that can be solved for Jₘ and then Iₘ, yielding the exact solution to the deconvolution. Using the common multiplier, E, and Eqn. (14), Eqn. (15) may be expressed alternatively as:

$${I}_{m} = {\sum }_{m = 0}^{M} {A}_{m} {J}_{m} = E {\sum }_{m = 0}^{M} {A}_{m} {D}_{m} \qquad ( 74 )$$

representing the solution of the deconvolution, where Aₘ is the “structural” part of the relationship between Iₘ and Jₘ. Note that Iₘ represents the coefficients of the actual (undistorted) measurement or image and Jₘ represents a set of dummy variables. It is desirable to be able to move back and forth between the two sets.

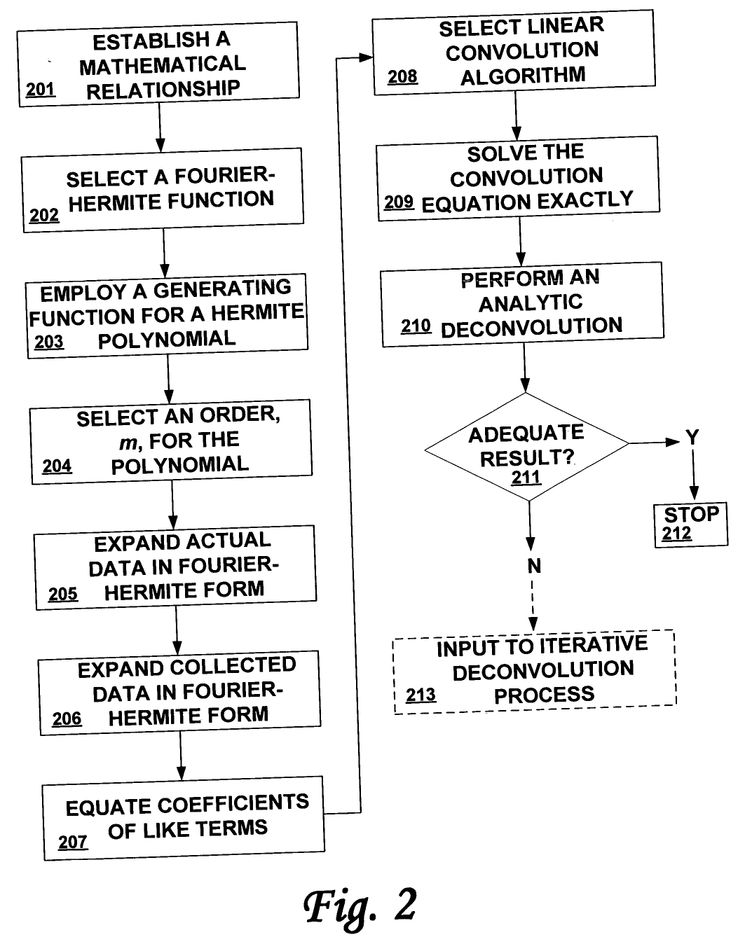

Refer to FIG. 2, a flow chart of a process yielding accurate representations of actual measurement or image data by deconvolving data collected by systems, such as optical detectors, whose point spread function response follows a Gaussian distribution.

The process comprises:

establishing 201 a mathematical relationship as a general convolution integral equating the actual measurement or image data to the collected measurement or image data;

selecting 202 a Fourier-Hermite function;

employing 203 a generating function for Hermite polynomials for expanding a Fourier-Hermite series of the Fourier-Hermite function to establish a linear mathematical relationship between the actual and the collected measurement or image data;

selecting 204 an order, m, of the Fourier-Hermite polynomial such that m also determines the number of terms for the representation of the measurement or images;

expanding 205 the actual measurement or image data in a Fourier-Hermite form with unknown (to-be-determined) coefficients by employing a series of special transformations to convert the side of the mathematical relationship representing the actual measurement or image to a Fourier-Hermite series;

expanding 206 the collected measurement or image data in a Fourier-Hermite form;

equating 207 coefficients of like terms on each side of the mathematical relationship to relate the coefficients of the actual and collected measurement or images;

selecting 208 a linear convolution algorithm from which a general convolutional equation is derived;

solving 209 the resultant general convolution equation exactly, in closed analytical form, as a linear convolution equation, such that using this process to evaluate the general convolution integral yields a form proportional to a Gaussian function times a power series that is defined with a finite number of terms, m, and incorporates the unknown coefficients of the actual measurement or image data as presented in a Hermite function, such that a solution in closed analytic form provides a satisfactory solution to the general convolution integral without approximation; and

performing 210 an analytic deconvolution of the resultant linear convolution algorithm by employing classical deconvolution algorithms solely;

evaluating 211 the adequacy of the result such that the analytic deconvolution yields a solution having acceptable error levels;

if adequate, stop 212;

if desirable to achieve greater accuracy, input 213 to an iterative deconvolution process.

As with other embodiments, this process may be used to initiate any conventional iterative nonlinear deconvolution technique to further refine the accurate representations. Note that fewer iterations are needed because of the accurate starting point provided.

### EXAMPLE

For simplicity, a process is described for one-dimensional (1-D) imagery collection such as produced by the HYDICE sensor. With these types of sensors, a single line of optical detectors/pixels oriented transverse to the direction of platform travel scans the angular line of sight electronically in a “whiskbroom” operation. McKeown, D. M. et al., Fusion of HYDICE Hyperspectral Data with Panchromatic Imagery for Cartographic Feature Extraction, IEEE Trans. Geoscience and Remote Sensing, 37, No. 3, pp. 1261-1277, May 1999. The individual 1-D rows are later combined in the HYDICE imaging process to form a matrix for building 2-D images.

### Sample Calculation

Assume J₀, J₁, and J₂ represent a set of dummy variables and

A(R)=ΣJₘHₘ(R)=J₀H₀+J₁H₁+J₂H₂ (75)

The Hermite polynomials of orders one, two and three are:

H₀(R)=1

H₁(R)=2R (76)

H₂(R)=4R²−2

By substitution:

B(R)=ΣJₘHₘ(R)=ΣIₘR^{m}=(J₀−2J₂)+(2J₁)R+(4J₂)R² (77)

It follows that values for Iₘ are given by:

I₀=(J₀−2J₂)

I₁=2J₁ (78)

I₂=4J₂

and conversely,

$${J}_{0} = {I}_{0} + \frac{1}{2} {I}_{2} \\ {J}_{1} = \frac{1}{2} {I}_{1} \\ {J}_{2} = \frac{1}{4} {I}_{2} \qquad ( 79 )$$

Dealing with Eqn. (73) again:

$$\begin{matrix}{ⅇ}^{\frac{- {R}^{2}}{2}} {\sum }_{m = 0}^{2} {D}_{m} {H}_{m} ( R ) = {( \frac{a}{2 b} )}^{\frac{1}{2}} {ⅇ}^{\frac{- {R}^{2}}{2}} {\sum }_{m = 0}^{2} {{J}_{m} ( 2 )}^{\frac{m}{2}} {H}_{m} ( R ) & ( 80 ) \\ or & \\ {\sum }_{m = 0}^{2} {D}_{m} {H}_{m} ( R ) = C {\sum }_{m = 0}^{2} {{J}_{m} ( 2 )}^{\frac{m}{2}} {H}_{m} ( R ) & ( 81 ) \\ = {( \frac{a}{2 b} )}^{\frac{1}{2}} {\sum }_{m = 0}^{2} {{J}_{m} ( 2 )}^{\frac{m}{2}} {H}_{m} ( R ) & \end{matrix}$$

In expanded form, Eqn. (81) reads:

$${D}_{0} {H}_{0} ( R ) + {D}_{1} {H}_{1} ( R ) + {D}_{2} {H}_{2} ( R ) = C [ {J}_{0} {H}_{0} ( R ) + {{J}_{1} ( 2 )}^{\frac{1}{2}} {H}_{1} ( R ) + 2 {J}_{2} {H}_{2} ( R ) ] \qquad ( 82 )$$

Equating coefficients of like terms involving Hermite polynomials:

$${D}_{0} = C {J}_{0} \\ {D}_{1} = C {{J}_{1} ( 2 )}^{\frac{1}{2}} \\ {D}_{2} = 2 C {J}_{2} \qquad ( 83 )$$

To obtain the solution of the convolution problem, substitute Eqns. (78) into Eqns. (82):

$${D}_{0} = C [ {I}_{0} + \frac{1}{2} {I}_{2} ] \\ {D}_{1} = {C ( \frac{1}{2} )}^{\frac{1}{2}} {I}_{1} \\ {D}_{2} = {( \frac{C}{2} )}^{\frac{1}{2}} \qquad ( 84 )$$

To solve the deconvolution problem, these relations are inverted:

$${I}_{0} = [ \frac{{D}_{0}}{C} ] - [ \frac{{D}_{2}}{C} ] \\ {I}_{1} = {( 2 )}^{\frac{1}{2}} [ \frac{{D}_{1}}{C} ] \\ {I}_{2} = 2 [ \frac{{D}_{2}}{C} ] \qquad ( 85 )$$

where, remembering Eqn. (6):

a is a measure of the relative width, and

b is an inverse measure of the relative height of the Gaussian system PSF and

D₀, D₁, and D₂ are the full set of three actual (undistorted) image parameter measures.

While the invention has been described in terms of its preferred embodiments, those skilled in the art will recognize that the invention can be practiced with modifications within the spirit and scope of the appended claims. For example, although the system is described in specific examples for topography, it will operate in areas of medicine, communications, and even business models where deconvolution is a preferred procedure. Thus, it is intended that all matter contained in the foregoing description or shown in the accompanying drawings shall be interpreted as illustrative rather than limiting, and the invention should be defined only in accordance with the following claims and their equivalents.

We claim:

1. A process for deconvolving data collected by a device the point spread function response of which follows a Gaussian distribution, said process undertaken to accurately estimate actual parameters derivable from said data, comprising:
forming at least one mathematical relationship having a first mathematical equivalent of said data on one side of an equality and a second mathematical equivalent of said parameters on the other side of said equality;
selecting an order, m, of a Hermite function for modifying said at least one mathematical relationship;
modifying said mathematical relationship to form at least one Hermite function therein,
wherein forming said at least one Hermite function permits identification of at least one like item, having a coefficient, on each side of said equality, said coefficients associated with said actual parameters being unknown;
developing at least one set of linear equations from said mathematical relationship that relate to said coefficient of each said at least one like items;
solving said set of linear equations for said unknown coefficients,
wherein solving said set of linear equations produces an exact solution to said convolution; and
deconvolving said set of linear equations.

2. The process of claim 1 in which said mathematical relationship is of the form:
D(z)=∫p(z−x)I(x)dx
where:
D(z)=said data;
I(x)=expression involving said parameters; and
p(x) point spread function (PSF) representing response distribution of said device.
and
$${Y}_{m} = {\int }_{- ∞}^{∞} {ⅇ}^{- \frac{{( z - x )}^{2}}{2}} {ⅇ}^{- \frac{{x}^{2}}{2}} {H}_{m} ( x ) ⅆ x$$
where:
Yₘ is said data represented at least partially as a Hermite function
said point spread function for said device is represented by
$${ⅇ}^{- \frac{z - {x}^{2}}{2}} ,$$
said Hermite Function is represented by
$${ⅇ}^{- \frac{{x}^{2}}{2}} {H}_{m} ( x ) ,$$
and
Hₘ(x) is a Hermite polynomial of order m.

3. The process of claim 1 initiating any conventional iterative deconvolution techniques to further refine said data,
wherein fewer iterations will be needed as compared to conventional methods of deconvolution because of the accurate starting point provided by said process.

4. A process for deconvolving output from detectors, the point spread function response of said detectors following a Gaussian distribution, said process undertaken to accurately estimate environments derivable from said output, comprising:
forming at least one mathematical relationship having a first mathematical equivalent of said output on one side of an equality and a second mathematical equivalent of said environments on the other side of said equality;
selecting an order, m, of a Hermite function for modifying said equality,
wherein, said order also determines the number of terms for the representation of said environments;
modifying said equality to form at least one Hermite function within the equality,
wherein forming said Hermite function permits identification of at least one like item, having a coefficient, on each side of said equality;
developing at least one set of linear equations from said equality that relate to said coefficient of each said at least one like items; and
solving said set of linear equations for said coefficient of each said like item,
wherein solving said set of linear equations produces an exact solution to said convolution, in turn, permitting deconvolution using linear relationships.

5. The process of claim 4 in which said mathematical relationship is of the form:
D(z)=∫p(z−x)I(x)dx
where:
D(z)=said output;
I(x)=said environments; and
p(z−x)=a transformed function of the point spread function (PSF) representing response distribution of said device

6. The process of claim 4 initiating any conventional iterative nonlinear deconvolution technique to further refine said output, wherein fewer iterations will be needed as compared to conventional methods of deconvolution because of the accurate starting point provided by said process.

7. A process yielding accurate representations of actual image data by deconvolving image data collected by optical detectors, the point spread function response of said detectors following a Gaussian distribution, comprising:
establishing a first mathematical relationship as a general optical convolution integral equating said actual image data to said collected image data;
selecting a Fourier-Hermite function; employing a generating function for Hermite polynomials for expanding a Fourier-Hermite series of said Fourier-Hermite function to establish a linear mathematical relationship between said actual and said collected image data;
selecting an order, m, of said Fourier-Hermite polynomial,
wherein, m also determines the number of terms to be used for the representation of said images;
expanding said actual image data in said Fourier-Hermite form with unknown coefficients by employing a series of special transformations to convert the side of said mathematical relationship representing the actual image to a Fourier-Hermite series;
expanding said collected image data with known coefficients in said Fourier-Hermite form;
equating said known and unknown coefficients of like terms on each side of the mathematical relationship to relate the coefficients of said actual and said collected image data;
selecting an algorithm represented by a set of linear equations;
solving said linear equations exactly,
wherein using said process yields a form proportional to a Gaussian function times a power series that is defined with a finite number of terms and incorporates said unknown coefficients of said actual image data as presented in a Hermite function, and
wherein a solution in closed analytic form provides a satisfactory solution to said general definitional convolution integral without approximation; and
performing an analytic deconvolution of said convolution equation by inverting said linear equations,
wherein said analytic deconvolution yields a solution having acceptable error levels.

8. The process of claim 7 initiating any conventional iterative deconvolution techniques to further refine said accurate representations, wherein fewer iterations will be needed as compared to conventional methods of deconvolution because of the accurate starting point provided by said process.
